(19) United States
(12) Patent Application Publication
(10) Pub. No.: US 2018/0238178 A1
(43) Pub. Date: Aug. 23, 2018

(54) HYBRID CERAMIC MATRIX COMPOSITE COMPONENTS FOR GAS TURBINES

(71) Applicant: Siemens Aktiengesellschaft, München (DE)

(72) Inventors: Stefan Lampenscherf, Poing (DE); Ramesh Subramanian, Oviedo, FL (US); Jay A. Morrison, Mims, FL (US)

(21) Appl. No.: 15/554,727

(22) PCT Filed: Mar. 27, 2015
(86) PCT No.: PCT/US2015/023017

§ 371 Date: Aug. 31, 2017

(51) Int. Cl. F01D 5/28; F01D 9/04; B32B 18/00; B33Y 10/00; B33Y 80/00; B32B 3/26; C04B 37/00

(52) U.S. Cl. CPC F01D 5/284; F01D 9/041; F01D 5/282; B32B 18/00; B33Y 10/00; B23K 26/342; B32B 3/266; C04B 37/003; F05D 2230/31; F05D 2300/6033; B32B 2603/00; B33Y 80/00

(57) ABSTRACT

A hybrid component (45) is provided including a plurality of laminates (10) stacked on one another to define a stacked laminate structure (58). The laminates (10) include a ceramic matrix composite material (22) and at least one opening (24) defined therein. A metal support structure (56) may be additively manufactured through each opening (24) so as to extend through the stacked laminate structure (58).

### FIELD OF THE INVENTION

The present invention relates to high temperature materials for use in high temperature environments, such as gas turbines. More specifically, aspects of the present invention relate to mechanically and thermally decoupled hybrid components comprising a stack of laminates formed from a ceramic matrix composite (CMC) material and at least one metallic support structure that extends there through. Aspects of the present invention further include processes for making the hybrid component.

### BACKGROUND OF THE INVENTION

Gas turbines comprise a casing or cylinder for housing a compressor section, a combustion section, and a turbine section. A supply of air is compressed in the compressor section and directed into the combustion section. The compressed air enters the combustion inlet and is mixed with fuel. The air/fuel mixture is then combusted to produce high temperature and high pressure gas. This working gas is then ejected past the combustor transition and injected into the turbine section of the turbine.

The turbine section comprises rows of vanes which direct the working gas to the airfoil portions of the turbine blades. The working gas travels through the turbine section, causing the turbine blades to rotate, thereby turning the rotor. The rotor is also attached to the compressor section, thereby turning the compressor and also an electrical generator for producing electricity. A high efficiency of a combustion turbine is achieved by heating the gas flowing through the combustion section to as high a temperature as is practical. The hot gas, however, may degrade the various metal turbine components, such as the combustor, transition ducts, vanes, ring segments and turbine blades that it passes when flowing through the turbine.

For this reason, strategies have been developed to protect such components from extreme temperatures such as the development and selection of high temperature materials adapted to withstand these extreme temperatures and cooling strategies to keep the components adequately cooled during operation. For one, ceramic matrix composite (CMC) materials have been developed with a resistance to temperatures up 1200° C. CMC materials include a ceramic matrix reinforced with ceramic fibers. Typically, the fibers may have a predetermined orientation to provide the CMC materials with additional mechanical strength. It has been found, however, that forming turbine components from CMC materials may be challenging due to the difficulty in orientating fibers at edges of the component in the complex shapes typical of many turbine components. For this reason, components formed from stacked CMC laminates have been developed. The stacked CMC laminates comprise a plurality of laminates formed from a CMC material with fibers in a desired orientation. By including a plurality of flat laminates, each having a desired fiber orientation and shape, the overall composition and shape of the component may be better controlled.

It has further been found that while CMC materials provide excellent thermal protection properties, the mechanical strength of CMC materials is still notably less than that of corresponding high temperature superalloy materials. For this reason, attempts have been made to add further strengthening materials to the CMC material or support the CMC material with a material have a greater mechanical strength. For example, in some instances, the stacked laminates may be slid over a rod and retained/compressed via a retaining structure or other structure that compresses the stack of laminates.

One major issue with this approach is casting/manufacturing tolerances become difficult to perfect for each of the laminates such that the interface of the CMC laminate plate and the rod is within tolerances throughout a complete length (e.g., height) of the entire component, particularly with relatively large structures, such as blades or vanes. Still further, while oxide and non-oxide CMC materials can survive temperatures in excess of 1200° C., they can only do so for limited time periods in a combustion environment without being cooled. Thus, adequate cooling mechanisms are further needed for components formed entirely or substantially from CMC materials.

### BRIEF DESCRIPTION OF THE DRAWINGS

The invention is explained in the following description in view of the drawings that show:

FIG. 1 is a perspective view of a laminate prior to addition of a metal core in accordance with an aspect of the present invention.

FIG. 2 is a perspective view of laminate comprising a metal core within openings in the body of the laminate in accordance with an aspect of the present invention.

FIG. 3 is a top view of a metal core within an opening in accordance with an aspect of the present invention.

FIG. 4 is a top view of a laminate having a gap between the metal core and a wall of the body of the CMC material portion in accordance with an aspect of the present invention.

FIG. 5 is a top view of a laminate comprising a biasing member within a gap in accordance with an aspect of the present invention.

FIG. 6 is a top view of a laminate comprising a metallic portion having a lattice structure that provides the metallic portion with a degree of elasticity within a gap in accordance with an aspect of the present invention.

FIG. 7 is a perspective view of a laminate comprising a metal core having a plurality of fingers extending to the CMC material in accordance with an aspect of the present invention.

FIG. 8 is a perspective view of a laminate comprising a metal core having a plurality of fingers interlocked with projections from the laminate in accordance with an aspect of the present invention.

FIG. 9 is a perspective view of a laminate comprising a metal core that includes a cooling channel extending through each metal core in accordance with an aspect of the present invention.

FIG. 10 illustrates a hybrid CMC/metal stationary vane formed from a plurality of laminates in accordance with an aspect of the aspect of the present invention.

FIG. 11A-11H illustrates a process for making a hybrid CMC/metal component in accordance with an aspect of the present invention.

FIG. 12A-12C illustrates another process for making a hybrid CMC/metal component in accordance with an aspect of the present invention.

FIG. 13 illustrates a hybrid CMC/metal gas turbine blade formed from a plurality of laminates in accordance with an aspect of the aspect of the present invention.

FIG. 14 illustrates a stacked laminate component comprising a metal cap recessed in a top laminate in accordance with an aspect of the present invention.

FIG. 15 illustrates a stacked laminate component comprising a full metal tip cap in accordance with an aspect of the present invention.

FIG. 16 illustrates a stacked laminate component wherein portions of the metal support structure overlap portions of the laminates, and vice-versa, in accordance with an aspect of the present invention.

### DETAILED DESCRIPTION OF THE INVENTION

In accordance with one aspect, the present invention is directed to a component such as a turbine component which comprises a laminate stack including a plurality of laminates comprising a ceramic matrix composite (CMC) material and having one or more metal support structures extending through the laminate stack. The laminates may be mechanically and/or thermally decoupled from one another yet interface with the one or more common metal support structures to allow for improved cooling of the component and/or load distribution throughout the component.

In accordance with one aspect, there are provided processes for forming a mechanically and thermally decoupled component for use in high temperature components, such as a gas turbine component. In accordance with another aspect, the processes described herein construct a CMC/metal hybrid component via forming at least metal support structure for a stack of CMC laminates on a layer by layer basis via an additive manufacturing process as each CMC laminate is added to the stack. In this way, the hybrid component comprises optimized dimensions and properties (e.g., an interface between the metal and CMC material) at each laminate level in the stack in contrast to known methods. In known methods, the larger the component, the greater the difficulty that would be expected in providing optimal interfaces between the CMC material and metal along an entire radial length of the component. For example, gaps may exist between the CMC material and a rod (when used) at some heights in the stack where a flush interface would be more desirable.

In addition, by building the component layer by layer through the additive manufacturing process, the CMC material of the laminates interface with a common metal support structure yet are mechanically and thermally decoupled from one another. In this way, load transfer and/or thermal transfer, for example, between adjacent laminate plates may be substantially reduced or eliminated. Still further, the composition of the CMC hybrid component may be optimized layer by layer throughout the component. For example, it is known that turbine components may experience greater temperatures at a mid-portion of the component in certain configurations. In such case, the CMC material may have an increased resistance to temperature extremes, oxidation, corrosion, and/or loads at certain portion of the component versus others via adjusting a shape or dimension of the metal material at particular levels in the stack, for example.

The hybrid components described herein comprising stacked ceramic matrix composite (CMC) laminates and one or more additively manufactured metal support structures extending there through, and processes for making the same, have multiple benefits:
In one aspect, the hybrid components and/or processes described herein take advantage of the inherent CMC material properties which provide excellent thermal protection for the metal support. At the same time, the laminated architecture and the mechanical support provided by the metallic support structure inhibits critical interlaminar failure of the CMC material.
In still another aspect, the hybrid components and/or processes described herein enable increased exposure temperatures and significant reduction of cooling air requirements.
In still another aspect, the hybrid components and/or processes described herein may enable the generation of complex component and core geometries. This provides the capability to custom fit the CMC material and the metal material at each laminate in the laminate stack.
In still another aspect, the hybrid components and/or processes described herein may provide fixation/clamping of the CMC laminates to one another yet do not require that the laminates in the stack move in unison or as a whole.
In still another aspect, the hybrid components and/or processes described herein may allow for optimized cooling air flow (when cooling channels are present in the metal cores) through the metal support structure, as well as improved heat transfer between the CMC material and the metal material.
In still another aspect, the hybrid components and/or processes described herein may allow for rapid prototyping of components with various complex shapes and facilitates inexpensive and rapid modifications to prior-formed prototype components.
In still another aspect, the hybrid components and/or processes described herein may allow one to vary cross-section area, shape, and topology of the metal support structure to improve mechanical strength and heat transfer of the component.
In still another aspect, the hybrid components and/or processes described herein may allow for the manufacture of a component having a gradient of CMC material to metal material throughout the component.
In still another aspect, the hybrid components and/or processes described herein described herein may allow for improved distribution of centrifugal loads along a length of the component.
In still another aspect, the hybrid components and/or processes described herein may allow for reduced loading on the metallic support structure.

Each aspect may form independent inventions separate and distinct from other aspects, or aspects may be combined. For example, mechanically and thermally laminates may be separate and distinct from additive manufacturing, and are not necessarily dependent upon being formed from an additive manufacturing process.

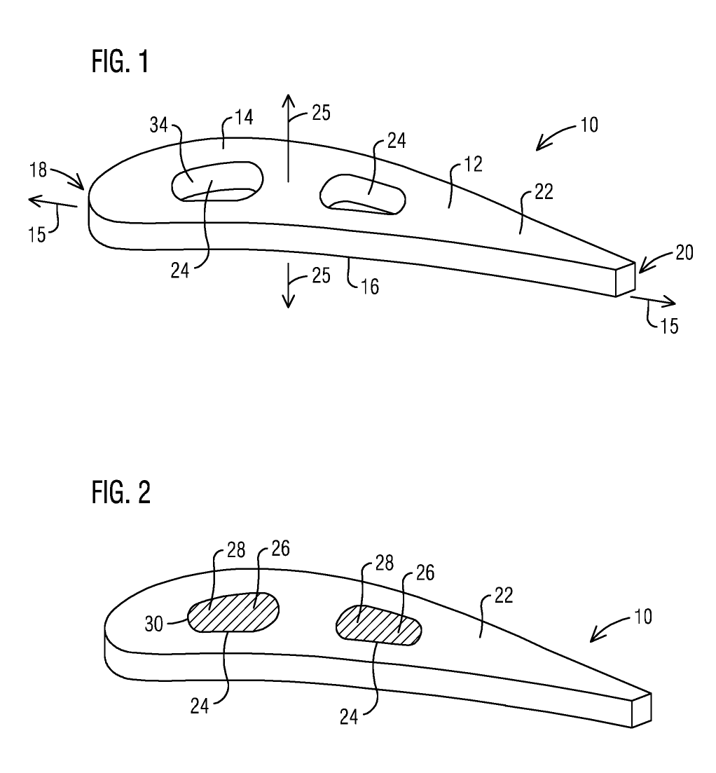

Referring now to the Figures, FIG. 1 shows a laminate 10 comprising a body 12 having a top surface 14 and a bottom surface 16 extending between a leading edge 18 and a trailing edge 20. In one aspect, the plurality of the individual laminates, e.g., laminate 10, described herein may be stacked as a metallic support structure is formed through the stack. In an embodiment, the metallic support structure is formed via an additive manufacturing process. While the immediately following discussion describes exemplary embodiments of an individual laminate 10 at any given position in the stack, it is contemplated that a component as described herein will comprise a plurality of such laminates 10 and include one or more metal support structures extending through the laminates 10.

Referring again to FIG. 1, the laminate 10 is formed at least in part from a ceramic matrix composite (CMC) material 22. Within the body 12, there are defined one or more openings 24 extending from the top surface 14 to the bottom surface 16 through the body 12. In the embodiment shown, there are shown two openings 24 in the body 12; however, it is understood that the present invention is so limited and that a lesser or greater number of openings 24 may be provided.

Each laminate 10 may have an in-plane direction 15 and a through thickness direction 25. The through thickness direction 25 can be substantially normal to the in-plane direction 15. The through thickness direction 25 extends through the thickness of the laminate 10 between the top surface 14 and bottom surface 16 of the laminate 10. On the other hand, the in-plane direction 15 may be substantially parallel to at least one of the top surface 14 and the bottom surface 16 of the laminate 10.

Referring now to FIG. 2, exemplary laminate 10 may include a metal core 26 formed from a metal material 28 within the one or more openings 24. A plurality of the metal cores 26 formed on one another collectively define the metal support structure extending through the stack of laminates. Thus, the metal core 26 is intended to refer to a portion of the metal support structure within a respective laminate 10. As will be explained below, the metal core 26 may be formed via an additive manufacturing process, wherein a metal source material is melted and allowed to resolidify with a respective opening 24. As will also be explained below, the metallic core 26 for each laminate 10 that includes a metal material may be formed via additive manufacturing process as the laminates 10 are stacked on one another. In one aspect, the metal core 26 is formed within each opening 24 to a degree sufficient to provide an interface 30 between the metal core 26 and a wall 34 (FIG. 1) of the laminate 10 which defines each respective opening 24.

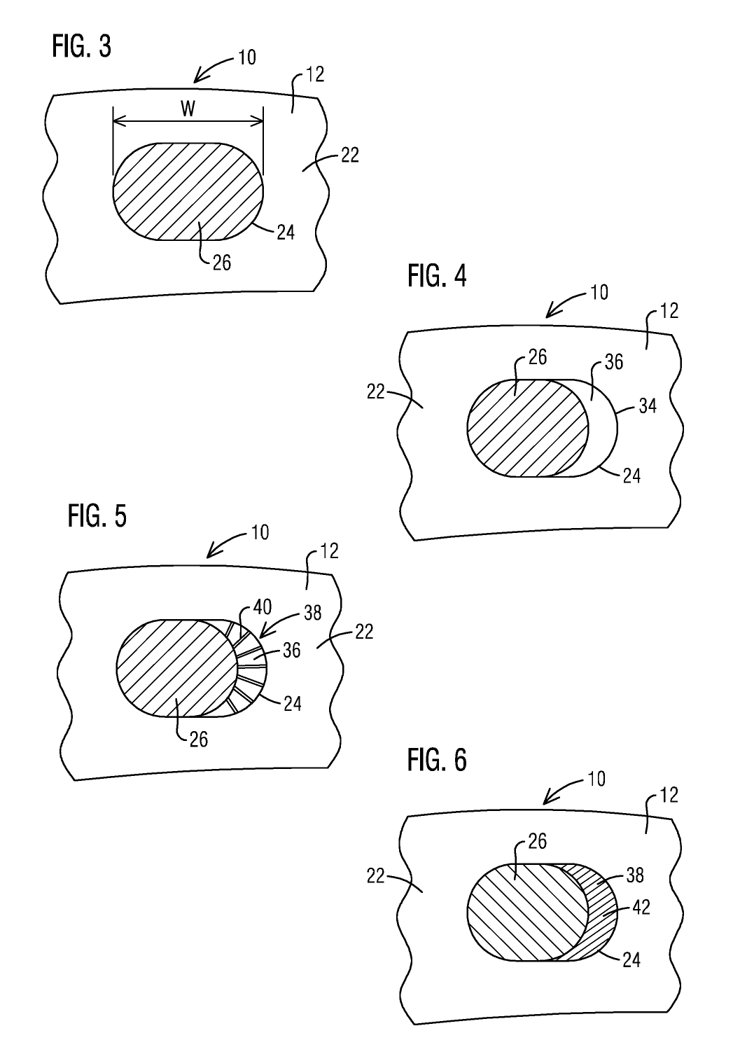

In one embodiment, as shown in FIG. 3 which is a top view of the body 12 of a laminate 10, the metal core 26 may fill an entire width (W) of the opening 24 during build up of the metal core 26 with the metal material 28 within the opening 24. In another embodiment, as shown in FIG. 4, metal material may be melted and cooled within the opening 24 to form the metal core 26 so as to leave one or more gaps 36 (hereinafter gap 36) defined between the metal core 26 and the wall 34.

In certain embodiments, the metal cores 26 may be configured for transfer a load from the body 12 of the laminate 10. To facilitate this, in certain embodiments, as shown in FIG. 5, a biasing member 38 may be disposed within the gap 36. By way of example only, the biasing member 38 may comprise a plurality of leaf springs 40. Alternatively, the biasing member 38 may comprise any other type of structure or material having a degree of elasticity. The biasing member 38 maintains a supporting force between the metal core 26 and the body 12 comprising the CMC material 22 yet also allows for load transfer against the biasing member 38. The biasing member 38 may further accommodate differential thermal expansion between the metal core 26 and the body 12. In certain embodiments, a cooling fluid may be provided from a suitable source and may flow in and around the biasing member 38 and within the gap 36 for cooling of the CMC material 22 and/or the metal core 26.

In another aspect, as shown in FIG. 6, the biasing member 38 may comprise an added metal portion 42 which may also be formed by an additive manufacturing process so as to have a lattice or other structure which provides the portion with a greater degree of bias/elasticity relative to the metal core 26. In this way, the added metal portion 42 also maintains a supporting force between the metal core 26 and the body 12 comprising the CMC material 22 yet allows for load transfer against the metal portion 42.

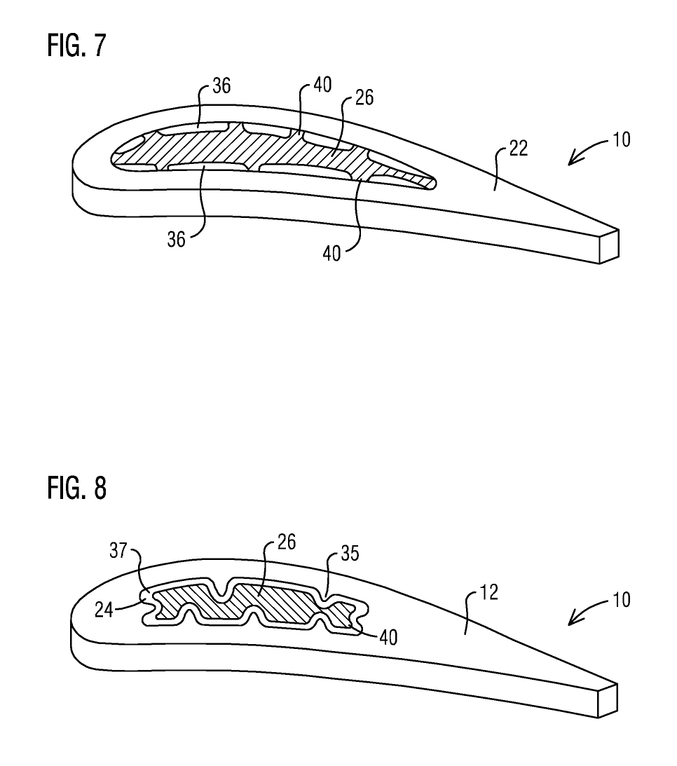

In still another embodiment, as shown in FIG. 7, the laminate 10 may comprise a plurality of gaps 36 and the metal core 26 may comprise a plurality of fingers 40 also formed from a metal material. The plurality of fingers 40 are configured to flex at least to an extent upon loading thereof so as to provide for a degree of load transfer between the CMC material 22 and the metal core 26. In addition, the plurality of fingers 40 may allow for thermal growth of the metal core 26 while constraining movement thereof. This may be of particular benefit when the component is a rotating part. Further, the plurality of fingers 40 may allow for thermal transfer between the CMC material 22 and the metal core 26. To achieve these objectives, in certain embodiments, the fingers 40 may extend or project radially outward from a central portion of the metal core 26 at an angle other than 90 degrees. In certain embodiments, a cooling fluid may be flowed up through the fingers 40 and within the gaps 36 to cool the CMC material 22 and the metal core 26.

In still another embodiment, the body 12 of the laminate 10 may also comprise a plurality of projections 35 extending from the body 12 of the laminate 10 into the opening 24, as well as the fingers 40 described above. These projections 35 may be configured to interlock or nearly interlock with respective ones of the fingers 40. In some embodiments, at least some of the fingers 40 may be in abutting relationship with the projections 35. In addition, a space 37 may be present between at least some of the metal core 26 and the projections 35 to allow further movement of the metal core 26 to accompany thermal growth while still constraining movement of the metal core 26 within the opening 24.

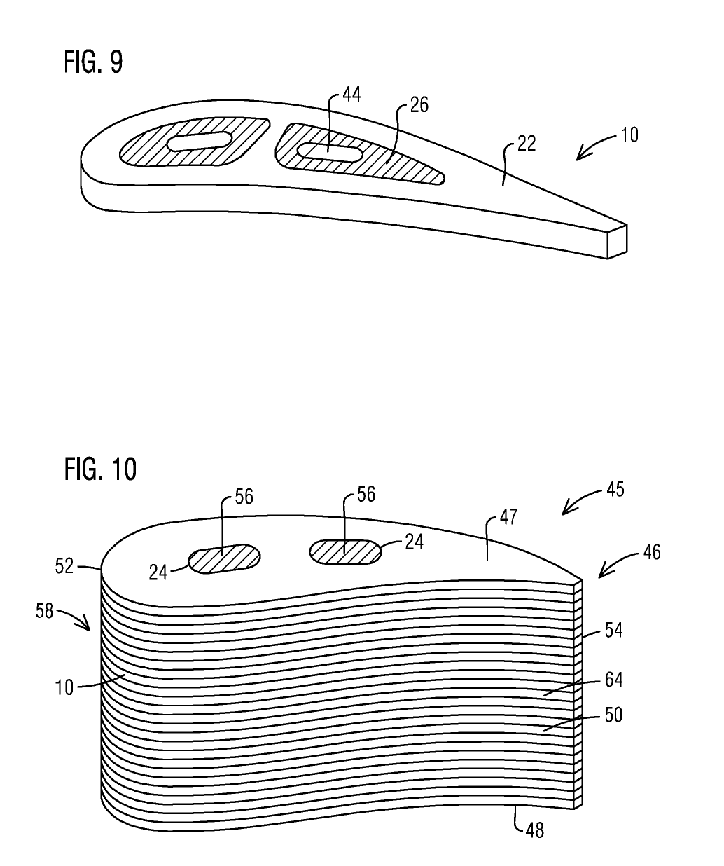

In still other embodiments, as shown in FIG. 9, the laminate 10 may comprise a metal core 26 having cooling channels 44 disposed through a body of the metal core 26 from a top surface to a bottom surface of the metal core 26. The channels 44 may be of any suitable or desired shape or dimension. A cooling fluid may be flowed up through the cooling channels 44 from a suitable source in order to cool the CMC material 22 and/or metal core 26.

It is appreciated that the embodiments shown in FIGS. 2-9 may be viewed as various non-limiting embodiments of an individual laminate 10 having a metal core 26 therein. Additional laminates in the same component may have different configurations of the metal core and a surrounding body formed at least in part from a CMC material, or may be entirely formed from the CMC material or a metal material. In stack of such laminates 10, the stack may be configured to distribute a load between the CMC material 22 and the metal core 26 in a more uniform manner along an entire length of the component, for example.

In the embodiments described herein, the CMC material 22 may include a ceramic matrix material that hosts a plurality of reinforcing fibers. The CMC material may be anisotropic, at least in the sense that it can have different strength characteristics in different directions. Various factors, including material selection and fiber orientation, can affect the strength characteristics of a CMC material. It is thus appreciated that the laminates 10 may be made of a variety of materials and the present invention is not limited to any specific materials. By way of example only, the ceramic matrix material 22 may comprise alumina, and the fibers may comprise an aluminosilicate composition consisting of approximately 70% alumina; 28% silica; and 2% boron (sold under the name NEXTEL™ 312). The fibers may be provided in various forms, such as a woven fabric, blankets, unidirectional tapes, and mats. A variety of techniques are known in the art for making a CMC material, and such techniques can be used in forming the CMC material 22 to be used in the laminates 10 described herein. Exemplary CMC materials 22 for use in the claimed invention are described in U.S. Pat. Nos. 7,153,096; 7,093,359; and 6,733,907, the entirety of each of which is hereby incorporated by reference.

As noted above, the selection of materials is not the only factor which governs the properties of the CMC material 22 as the fiber direction may also influence the properties of the material such as mechanical strength. The fibers may have any suitable orientation such as those described in U.S. Pat. No. 7,153,096.

The metal material 28 (and resulting metal support structure 56 comprising a plurality of metal cores 26) may comprise any suitable metal material which will provide an added strength to the laminate and/or component, as well as allow for an extent of cooling of the CMC material 22 by being in contact therewith or by being in close proximity thereto. In certain embodiments, the metal material 28 may comprise a superalloy material, such as a Ni-based or a Co-based superalloy material as are well known in the art. The term “superalloy” may be understood to refer to a highly corrosion-resistant and oxidation-resistant alloy that exhibits excellent mechanical strength and resistance to creep even at high temperatures. Exemplary superalloy materials are commercially available and are sold under the trademarks and brand names Hastelloy, Inconel alloys (e.g., IN 738, IN 792, IN 939), Rene alloys (e.g. Rene N5, Rene 41, Rene 80, Rene 108, Rene 142, Rene 220), Haynes alloys, Mar M, CM 247, CM 247 LC, C263, 718, X-750, ECY 768, 262, X45, PWA 1483 and CMSX (e.g. CMSX-4) single crystal alloys, GTD 111, GTD 222, MGA 1400, MGA 2400, PSM 116, CMSX-8, CMSX-10, PWA 1484, IN 713C, Mar-M-200, PWA 1480, IN 100, IN 700, Udimet 600, Udimet 500 and titanium aluminide, for example.

The individual laminates 10 described above are understood to represent a given cross-section of a component built from a stack of such laminates 10. In one embodiment, the component formed from a stack of laminates 10 as described herein may be a stationary component of a gas turbine, such as a stationary vane. In another embodiment, the component may comprise a rotating component for a gas turbine, such as a blade. However, the present invention is not so limited and any desired component may be formed according to the processes described herein.

Referring to FIG. 10, there is shown a component 45 in the form of a body portion of a stationary turbine vane 46 by way of example only. The vane 46 includes a radially outer end 47, a radially inner end 48, and an outer peripheral surface 50. The term “radial,” as used herein, is intended to describe the direction of the vane 46 in its operational position relative to the turbine in which it is housed. Further, the vane 46 may have a leading edge 52 and a trailing edge 54. As will be explained in detail below, a metal support structure 56 is formed through the openings 24 in each laminate 10 in a stack 58 (or stacked laminates 58 or stacked laminate structure 58) by a process such as an additive manufacturing process as the individual laminates 10 are stacked on one another. In an embodiment, the metal support structure 56 extends from radially outer end 47 to radially inner end 48. The metal support structure 56 comprises a plurality of the metal cores 26 (see FIGS. 2-9), each of which is may be individually customized at each laminate level.

In another embodiment, as shown in FIG. 13, the component 45 may be in the form of at least a portion of a blade 49 for a gas turbine. The blade 49 may be formed in the same manner as the vane 46 such that the blade 49 comprises a stack 58 of laminates 10 and one or more metal support structures 56 extending through the stack 58 within respective openings 24 in each of the laminates 10. In an embodiment, the blade 49 comprises an airfoil 51 formed from the laminates 10, which may be mounted on a platform 53 at its root. Thus, in this embodiment, at least a portion of the plurality of the laminates 10 have an airfoil shape.

In certain embodiments, the laminates 10 in the stack are mechanically decoupled and/or thermally decoupled from an adjacent laminate 10 such that at least one laminate 10 transfers an amount of a load or an amount of thermal energy to the metal support structure 56 independently from at least one other laminate 10. In addition, the laminates 10 in the stack 58 may be mechanically and/or thermally decoupled such that at least an amount of a load or thermal energy is not transmitted from one laminate 10 to an adjacent laminate 10 since the individual laminates are not bonded together, and the CMC material 22 and the metallic cores 26 are not bonded or fixed to one another. Nevertheless, a relationship between the CMC material 22 and the metal support structure 56 (and compositions thereof) may be customized at each level of the stack 58. In this way, the metal support structure 56 may provide mechanical support for the CMC material 22 and allow for the optimized load and/or thermal transfer from the CMC material 22 to the metal support structure 56. In the case of a rotating component, the stacked laminate/additive manufacturing approach described herein further allows for the distribution of centrifugal loads since the individual laminates 20 do not necessarily move in unison and are free to individually shift with respect to a common metal structural support, e.g., support structure 56.

It is appreciated that the individual laminates 10 forming the desired component may be substantially identical to each other; however, in certain embodiments, the laminates 10 may be different from one another. For example, the stacked laminates 58 may comprise laminates 10 that are distinct in thickness, size, shape, density, fiber orientation, porosity, and the like. In certain embodiments, a metal core 26 associated with one laminate 10 may be of a different composition, shape, and dimension relative to a metal core 26 associated with another distinct laminate 10. Further, any one or more of the laminates 10 may be in the form of a flat plate and may have straight or curved edges. In other embodiments, the laminates 10 may even have non-planar abutting surfaces.

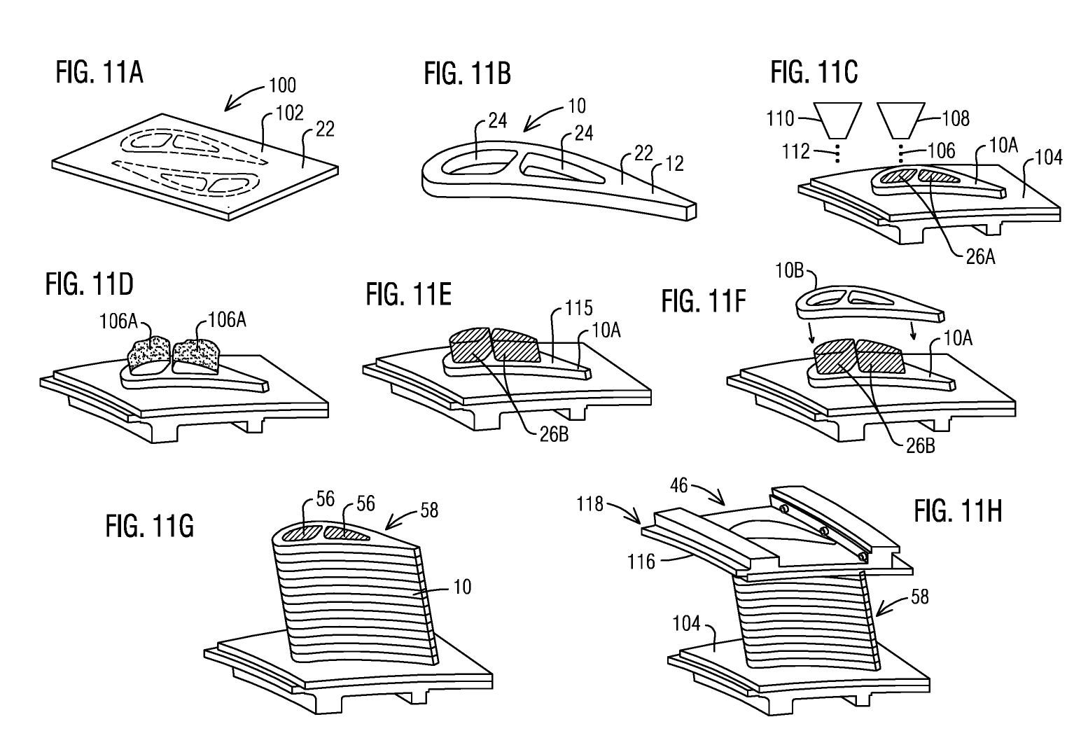

Turning now to FIGS. 11A-H, there is shown an exemplary process 100 (shown generally FIG. 11A) in accordance with an aspect of the present invention. In the embodiment shown, a stationary vane is formed by the process, although it is understood that the present invention is not so limited to the manufacture of stationary vanes and that other components of various sizes and shapes may be formed by the processes described herein for various applications.

As shown in FIG. 11A, the CMC material 22 may initially be provided in the form of a substantially flat plate 102. From the flat plate 102, as shown in FIG. 11B, the body 12 of any one or more laminates 10 may be cut out, such as by water jet or laser cutting to form a desired body shape (e.g., an airfoil shape) and to provide the desired number and dimensions of the openings 24. Forming the laminates 10 from flat plates 102 can provide numerous advantages. For one, a flat plate provides a strong, reliable, and statistically consistent form of the CMC material. As a result, the flat plate approach may avoid manufacturing difficulties that have arisen when fabricating tightly curved configurations. For example, flat plates may be unconstrained during curing, and thus do not suffer from anisotropic shrinkage strains.

In an embodiment, the assembly of the laminates 10 in a stack 58 may occur after each laminate 10 is fully cured so as to avoid shrinkage issues. The flat CMC plates 102 also facilitate conventional non-destructive inspection. Furthermore, utilizing flat plates reduces the criticality of delamination-type flaws, which are difficult to identify. Moreover, dimensional control is more easily achieved as flat plates may be accurately formed and machined to shape using cost-effective cutting methods. A flat plate construction also enables scaleable and automated manufacturing processes.

Referring now to FIG. 11C, a base member 104 may be provided on which to stack a first laminate 10A of a series of laminates 10. In this embodiment, the base member 104 may comprise a platform for a stationary vane, e.g., a radially inward platform for the vane. Alternatively, the base member 104 may be any other suitable structure such as an already formed laminate as described herein or a laminate without an opening 24 or without a metal core 26 formed therein. In any case, a first laminate 10A is placed on the base member 104 and a metal source material 106 is added to the desired location or locations within the openings 24. In an embodiment, the metal source material 106 is provided from a suitable metal source 108, such as a hopper or the like, at a predetermined volume and feed rate.

Following deposition of the material 106, an energy source 110 such as a laser source focuses an energy beam 112 therefrom on the metal source material 106 within a respective opening 24 to melt a predetermined amount of the metal material 106 in a predetermined pattern according to a predetermined protocol to form molten metal within a respective opening 24. To accomplish this, the energy source 110 may be moved with respect to the substrate, e.g., laminate 10A, or vice-versa to position the energy source 110 at a desired location over the laminate 10A to melt the metal material 106. As is also shown in FIG. 11C, the molten metal will be allowed to cool actively or passively to provide two metallic cores 26A, in this instance, for the individual laminate 10A. The metallic cores 26A serve as first portions of respective metallic support structures 56, each of which may extend through the openings 24 in each of the laminates 10 of the stack 58 (see e.g., FIG. 10).

In this embodiment, to build the metal support structures 56 and to facilitate addition of a subsequently formed metal core 26B on top of metal core 26A, additional metal material 106A may be added on top of the preceding core 26A as is shown in FIG. 11D. Thereafter, the energy source 110 (FIG. 11C) may again direct an amount of energy 112 to melt the additional material 106A and the molten material may be allowed to cool (actively or passively) to form subsequent metal cores 26B as shown in FIG. 11E, each of which stands proud from a top surface 115 of the first laminate 10A.

In an embodiment, the formed metal core 26B may now act as a post onto which a subsequent laminate 10B may be placed over as shown in FIG. 11F. One advantage of this design is that the metal core 26B can be specifically configured for the corresponding laminate 10B, and may be customized in any desired manner (e.g., size, shape, material, for load or thermal transfer, to have a particular interface between the CMC material and metal core, and the like). By way of example only, with a stack of twenty laminates, it would be difficult to have a optimal interface between CMC material and metal core along the entire radial length if a long and rigid rod, for example, extended through the laminate stack from radially outer end 47 to radially inner end 48 (FIG. 10). In other words, the larger the structure being formed, the more difficult it is to provide the desired specifications, such as an optimal interface between CMC material and metal, at each and every radial position of the component. Thus, by utilizing additive manufacturing to build the metal support structure 56 layer by layer through the stacked laminated structure, parameters of the CMC material, metal, interface between the two, and any other structures in the component can be optimized at various intervals along a length of the component, which is not possible with a long rod or the like, for example.

Upon formation of the second metal core 26B, it is appreciated that the first metal core 26A and the second metal core 26B may become integral with one another to provide a portion of a metal support structure 56 extending radially through a respective opening 24 in the laminates 10. The process of formation of a subsequent core on an existing metal core and stacking of a laminate 10 on the subsequently formed core is repeated until an entire metal support structure 56 is formed on which the last laminate in the stack 58 can be added. As shown in FIG. 11G, when the last laminate 10 is added, the formation of the laminate stack 58 is completed and defines a stack of laminates 58 having metallic support structures 56, which may be customized at each laminate 10 in the stack 58, extending through the structures 56.

Thereafter, if necessary or desired, a top member 116 may be provided to define the top surface of the formed component 118, which, in this case, may be a stationary vane 46 as shown in FIG. 11H. In the embodiment shown, the top member 116 may comprise an outer radial platform in the case of a stationary vane. In other embodiments, such as is the case with the formation of a blade, the top member 116 may include an already formed laminate or even a laminate as described herein comprising CMC material without a metal core.

Once all the desired laminates are stacked on one another and a top member is applied (if present), manufacturing of the component may be finished by any desired process or processes such as machining, coating, and heat treating. In certain embodiments, it may be desirable to afford greater thermal protection to the component, especially those portions which will be exposed to high temperatures. In such case, one or more layers of a thermal insulating material or a thermal barrier coating 64 can be applied to the peripheral surface 50 (FIG. 10) of the component where desired. In one embodiment, the thermal barrier coating 64 may comprise a friable graded insulation (FGI), which is known in the art, such as in U.S. Pat. Nos. 6,670,046 and 6,235,370, which are incorporated by reference herein. In other embodiments, such thermal barrier coatings may be applied to an outer periphery of each laminate 10 prior to the stacking of the laminates 10.

In the embodiment described above, the subsequent metal core, e.g., 26B, was formed such that upon melting and resolidification of metal material 28, the formed metal core 26B was disposed above (stands proud) of a top surface of the previously provided laminate 10A. In this way, the subsequent laminate 10B can be added to the metal core 26B akin to sliding/placing a ring on a pole. Once the subsequent laminate 10B is disposed on the metal core 26B, a further metal core can be formed on the metal core 26B and the process repeated until the metal support structure 56 is fully formed and the last laminate 10 is placed on the stack 58. In an embodiment, with the final laminate 10 in the stack 58 to be added, the metal material 28 may be provided such that the metal core 26 of the last laminate 10 is formed so as to be flush with a top surface of the last laminate 10 as was shown in FIG. 11G.

It is appreciated that the placement of successive laminates 10 along with the formation of the metal support structure 56 through the openings 24 of the laminates may occur in any particular order. As explained above, a first laminate 10A may be laid down, metallic material 28 melted and resolidified within a respective opening 24, and then another laminate 10B may be positioned over the first laminate 10A. In some embodiments as explained above, a metal core 26A may be formed extending radially from a top surface 14 of the first laminate 10A, which acts as a post on which the subsequent laminate 10B may be positioned.

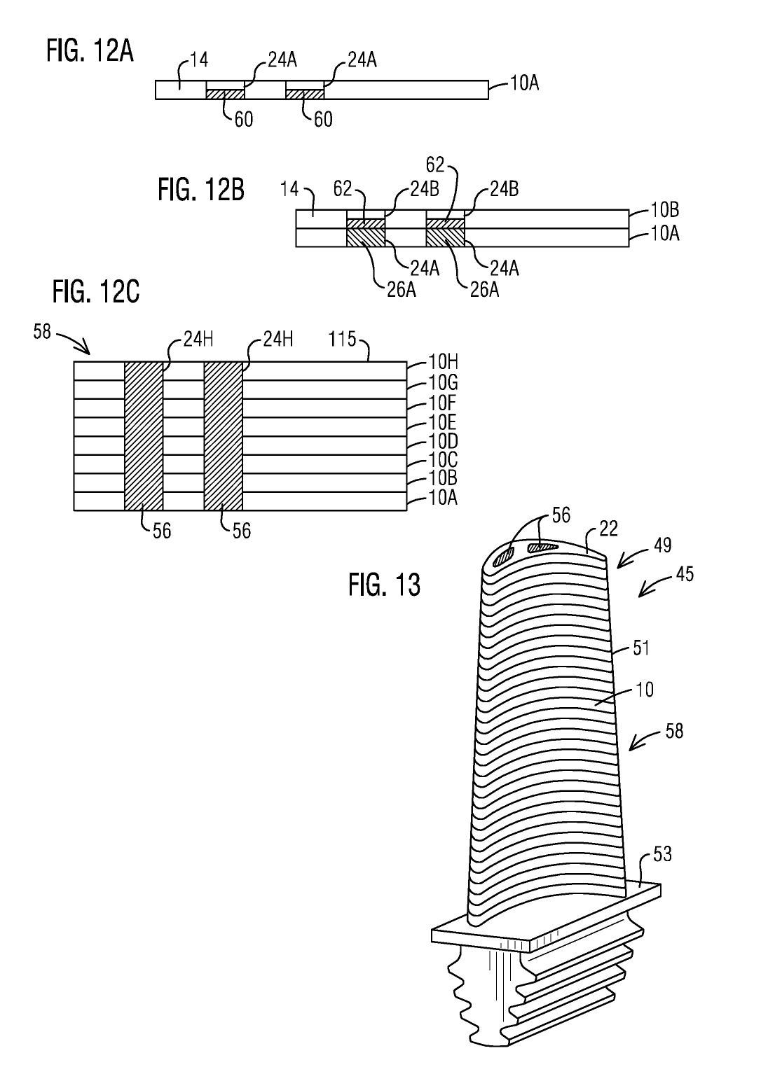

In other embodiments, metal material 106 may added within the openings 24A of laminate 10A such that when melted and resolidified, a portion 60 of a metal core 26 is formed in each opening 24, but is disposed below a top surface 14 of the corresponding laminate 10A. This is shown in FIG. 12A, which is a flat, two dimensional, and cross-sectional view in a through-plane direction of a laminate 10 as described herein for ease of illustration. It is understood that the laminate 10A of FIG. 12A may comprise an airfoil shape, for example. After formation of the portion 60, a subsequent laminate 10B may be stacked on the preceding (e.g., first) laminate 10A as shown in FIG. 12B. Thereafter, additional molten and resolidified metal material may fill the remaining depth within the openings 24A of the preceding laminate 10A to finish formation of a metal core 26 within the first laminate 10A. In addition, molten and resolidified metal material may fill a portion of the openings 24B of the subsequent laminate 10B, and thus may form a portion 62 of a metal core for laminate 10B. It is appreciated that this process may be repeated as necessary to add laminates 10C-10G until the last laminate 10H is placed on the stack 58. For the last laminate 10H, metal material may melted and resolidified within the openings 24H of the last laminate 10H such that the final metal cores 26H form completed metallic support structures 56 through the stack 58 which have an end flush with a top surface 115 of the final laminate 10H as shown in FIG. 12C.

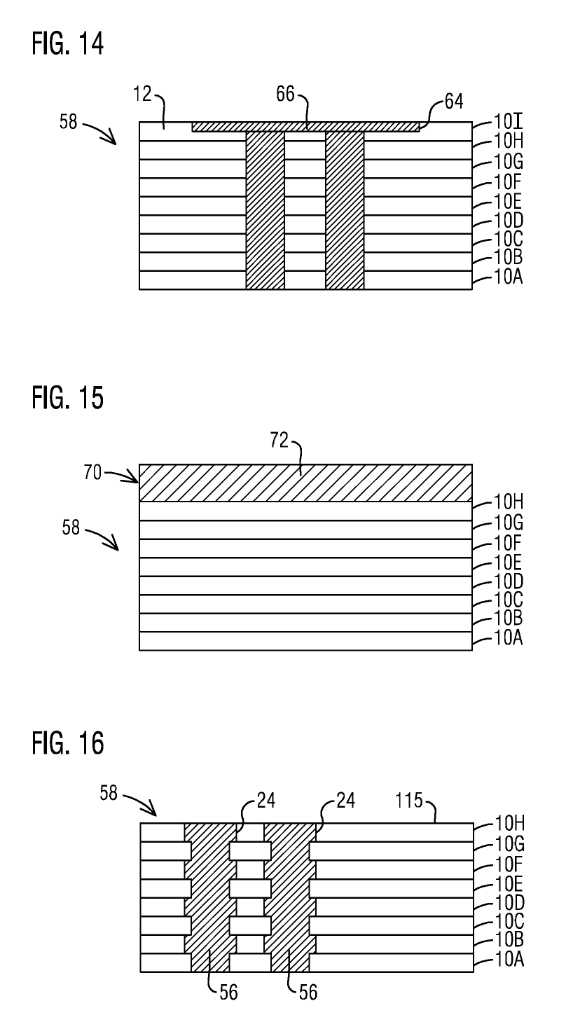

In other embodiments, a portion of or all of a top portion of the formed component may comprise a greater amount of metal material 28 in one or more of the outermost laminates. As shown in FIG. 14, for example, the topmost laminate 10I in the stack 58 may comprise a recess 64 in the body 12, which is filled with molten and resolidified metal material 66. In still another embodiment, as shown in FIG. 15, a top portion 70 of the stack 58 comprises a tip portion 72 which is entirely formed from metal material, and which may be of any desired shape.

It is further understood that the gaps, biasing members, or any other desired component or design may be formed within the openings 24 during the additive manufacturing process. It is appreciated also that the formation of gaps 36 may take place via the use of removable spacers and/or via control of additive manufacturing parameters such as laser intensity, duration, spacing between energy source and component, and the like.

In addition, in the embodiment shown in FIG. 12C, the metal support structure 56 comprises a relatively symmetrical form such that the dimensions of the openings and surrounding body of adjacent laminates are relatively the same or similar throughout the component. In another embodiment, as shown in FIG. 16, the component is instead formed by additive manufacturing (as described herein) in such a way that portions of the CMC laminates 10A-10H overlap portions of the metal support structure 56 (and vice-versa) so as to interlock the CMC laminates 10A-10H and the metallic support structures 56 in the stack 58. In this way, multiple portions of the metal support structure 56 overlap the CMC laminates 10A-10H, thus entrapping the CMC laminates 10A-10H via the metal support structure 56, such as in a vertical or engine radial direction. Such constructions may be useful to provide individual laminate supports to avoid separation and leakage paths (internal cooling air leaking out or hot gases leaking in) under certain loading conditions or in the event of an individual laminate fracture. Such constraint may also be applied in the case of rotating airfoils, to distribute the centrifugal loads from each laminate to the metal support structure 56. In the case of blade, this approach has advantage over the conventional spar-shell concepts which concentrate airfoil shell loads at the blade tip, thereby increasing the overall blade loading by placing the center of gravity towards the blade tip. In one aspect of the present invention, a load transfer occurs at each laminate in the stack, and thereby may reduce a centrifugal load.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1-11. (canceled)

12. A method for forming a hybrid component comprising:
stacking a plurality of laminates on one another to form a laminate stack, the plurality of laminates comprising a ceramic matrix composite material and an opening defined therein; and
forming a metal support structure extending through the openings and the laminate stack via melting and resolidifying successive layers of a metallic material before or after respective laminates are stacked on one another.

13. The method of claim 12, wherein the process comprises:
(a) providing a first laminate comprising a ceramic composite material and a first opening defined therein;
(b) forming a first portion of the metal support structure by melting and resolidifying a metallic material on the first laminate such that the first portion stands proud from a surface of the first laminate and extends from an opening thereof; and
(c) stacking a second laminate on the first laminate such that the first portion extends up into an opening of the second laminate.

14. The method of claim 13, wherein steps (a)-(c) are repeated at least twice.

15. The method of claim 13, further comprising:
forming a second portion of the metal support structure on the first portion, wherein the second portion stands proud of the second laminate; and
stacking a third laminate on the second laminate such that the second portion extends up into an opening of the third laminate.

16. The method of claim 15, wherein the first portion is flush with a top surface of the second laminate when the second laminate is stacked on the first laminate.

17. The method of claim 12, wherein the method comprises:
(a) providing a first laminate comprising a ceramic matrix composite material and a first opening defined therein;
(b) forming a first portion of the metal support structure within the opening of the first laminate;
(c) stacking a second laminate comprising a ceramic matrix composite material and a second opening defined therein on the first laminate (10A);
(d) forming an additional portion of the metal support structure within the first opening and the second opening.

18. The method of claim 17, further comprising:
(e) stacking a third laminate comprising a ceramic matrix composite material and a third opening defined therein on the second laminate (10B); and
(f) forming an additional portion of the metal support structure within the second opening and third opening.

19. The method of claim 18, wherein the steps (a)-(f) are repeated until a final laminate in the stack is provided, and wherein the metal support structure is formed so as to be flush with a top surface of the final laminate upon positioning of the final laminate on the stack.

20. The method of claim 12, further comprising:
defining a gap between the ceramic matrix composite material and the metal support structure within any one or more of the laminates.

21. The method of claim 20, further comprising providing a biasing member between the ceramic matrix composite material and the metal support structure within the gap.

22. The method in claim 12, wherein the component comprises a stationary component of a gas turbine.

23. The method of claim 22, wherein the stationary component comprises a stationary vane, and wherein the stationary vane further comprises an inner radial platform and an outer radial platform, and wherein the stack is disposed between the inner radial platform and the outer radial platform.

24. The method of claim 12, wherein the component comprises a rotating component of a gas turbine.

25. The method of claim 12, wherein the forming of the metal support structure comprises overlapping portions of the metal support structure with portions of the laminates such that the laminates are entrapped by the metal support structure.

26. (canceled)

27. A hybrid component comprising:
a plurality of laminates stacked on one another to define a stacked laminate structure, the plurality of laminates comprising a ceramic matrix composite material and at least one opening defined therein; and
a metal support structure additively manufactured through each opening so as to extend through the stacked laminate structure;
wherein portions of the metal support structure overlap portions of the laminates such that the laminates are entrapped by the metal support structure.

28. The component of claim 27, wherein the stacked laminate structure (58) comprises at least one laminate having at least one of a different shape, dimension, fiber orientation, metal composition, or ceramic matrix composite composition relative to at least one other laminate.

29. The component of claim 27, wherein the component comprises a stationary or rotating component of a gas turbine.

30. The component of claim 27, further comprising a friable graded insulation on a periphery of the stacked laminate structure.
